(19) United States
(12) Patent Application Publication
(10) Pub. No.: US 2005/0153261 A1
(43) Pub. Date: Jul. 14, 2005

(54) Abutment of implant system

(76) Inventor: Sang-Kohn Chang, Daegu-si (KR)

Correspondence Address: R. Neil Sudol, 714 Colorado Avenue, Bridgeport, CT, 06605-1601, US

(21) Appl. No.: 11/012,073

(22) Filed: Dec. 14, 2004

(30) Foreign Application Priority Data
Jan. 13, 2004 (KR) 10/2004/0002163

(51) Int. Cl. A61C 8/00

(52) U.S. Cl. 433/173

(57) ABSTRACT

The present invention relates to an abutment of an implant system. It is a primary object of the present invention an abutment of an implant system capable of achieving an escape groove of air compressed in an assembling hole in such a manner that a circular rim groove is formed at a post part of an abutment. In addition, it is capable of enhancing a surface contacting state in such a manner that a certain flexibility is provided at an upper side and a lower side of a post part. An easier operation work can be achieved in such a manner that it is easy to hold using a tool or a jig when an abutment is inserted into and is pulled out from a fixture. To achieve the above objects, in an implant system that includes a fixture having a taper assembling hole at an upper surface, an abutment having a taper post part so that it is inserted into the assembling hole of the fixture, and a restoration assembled to an upper side of the abutment, there is provided an abutment of an implant system comprising at least one circular rim groove formed at an outer surface of a lower side of an intermediate portion wherein the post part is assembled into the assembling hole.

### BACKGROUND OF THE INVENTION

1. Field of the Invention

The present invention relates to an abutment of an implant system, and in particular to an improved abutment of an implant system capable of enhancing an assembled state when an assembling hole of a fixture is assembled and achieving an easier operation in such a manner that a post part of an abutment is improved.

2. Description of the Background Art

Generally, in an implant system, a fixture is inserted into an alveolar and is osseointegrated with a bone, and an abutment adapted to support an implant is engaged with the fixture. A restoration is covered on the abutment. In the above implant, it is possible to independently plant one tooth. Since the thusly planted implant has a self-support function, so that it is not needed to cut a neighboring tooth for the damaged (removed) teeth. In a certain situation, it is possible to stably fix an artificial tooth. The implant has a long life span and a good look for thereby achieving many advantages.

The so-far known implants are implemented based on an external connection method and an internal connection member in a screw method. In addition, in a non-screw method, there is an internal connection method that does not needed screws based on a locking taper method.

The screw type implant system needs many parts, and a fabrication and its cost are too expensive, and an operation method is so complicated. Many complications may occur. The cost that a patient pays is too high.

In addition, in the screw type implant system, it is stable against a compression force when an inter-engagement function is performed in a mouth. When a tensional force is increased, the inserted screws may be loosened.

The clearances formed due to a bad connection state between a fixture and an abutment may be ways through which various bacteria are penetrated for thereby causing hygienic problems. In addition, inflammations may occur at a surrounding tissue.

In order to overcome the above problems, as shown in FIG. 1, an implant system of a non-screw method has been developed. In the above system, an engagement between parts is achieved based on a locking taper with a surface friction force.

Namely, when an assembling hole of a fixture is assembled with a post part of an abutment, a taper shaft and a taper hole are formed, so that a loosening is prevented based on their wedge functions.

However, when an assembling hole 11 formed in a conventional fixture 10 is assembled with a post part 21 of an abutment 20, the following problems occur.

First, the assembling hole 11 and the post part 21 are processed with matching tapers (about 1.5°). In this case, it is impossible to fabricate a full conical structure. Namely, since it is impossible to achieve a fill conical structure, the contacting portions of the upper and lower sides may be unnatural. A certain clearance may occur at the unnatural contacting portions. Various bacteria may penetrate into the clearances, resulting in a bad tooth health.

Second, when the post part 21 is inserted into the assembling hole 11, a certain amount of air may remain in the interior. Therefore, the post part may be lifted up by the compression of the remaining air. When the above state lasts for a certain time period, a certain clearance may occur or the post part 21 may get movable.

Third, a certain tool such as a holder or jig is used in order to insert the post part 21 of the abutment 20 into the assembling hole 11 of the implant 10. In the conventional art, the conventional abutment does not have a proper portion for fixing the same, so that the operation is very difficult.

### SUMMARY OF THE INVENTION

Accordingly, it is an object of the present invention to overcome the problems encountered in the conventional art.

It is another object of the present invention to provide an abutment of an implant system capable of achieving an escape groove of air compressed in an assembling hole in such a manner that a circular rim groove is formed at a post part of an abutment.

It is further another object of the present invention to provide an abutment of an implant system capable of enhancing a surface contacting state in such a manner that a certain flexibility is provided at an upper side and a lower side of a post part.

It is still further another object of the present invention to provide an abutment of an implant system capable of achieving an easier operation work in such a manner that it is easy to hold using a tool or a jig when an abutment is inserted into and is pulled out from a fixture.

To achieve the above objects, in an implant system that includes a fixture having a taper assembling hole at an upper surface, an abutment having a taper post part so that it is inserted into the assembling hole of the fixture, and a restoration assembled to an upper side of the abutment, there is provided an abutment of an implant system, comprising at least one circular rim groove formed at an outer surface of a lower side of an intermediate portion wherein the post part is assembled into the assembling hole.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating the construction of a conventional implant system;

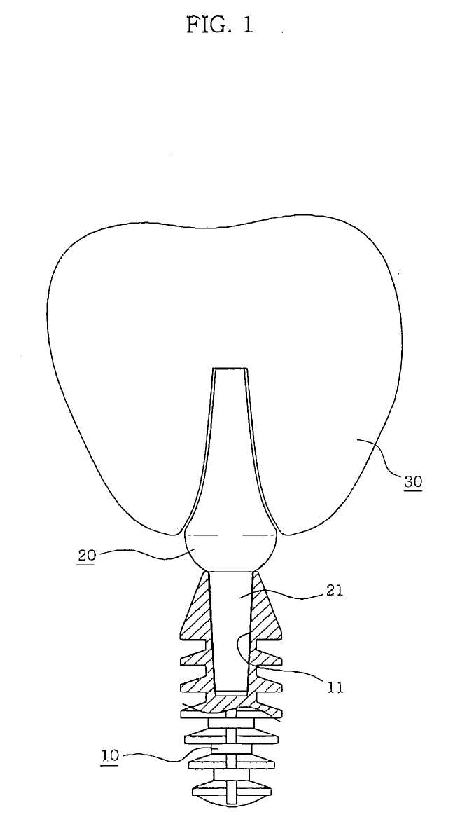

FIG. 2 is a cross sectional view illustrating an abutment according to the present invention; and

FIG. 3 is a cross sectional view illustrating an assembled state of an abutment of an implant system according to the present invention.

### DETAILED DESCRIPTION OF THE PREFERRED EMBODIMENTS

The preferred embodiments of the present invention will be described with reference to the accompanying drawings.

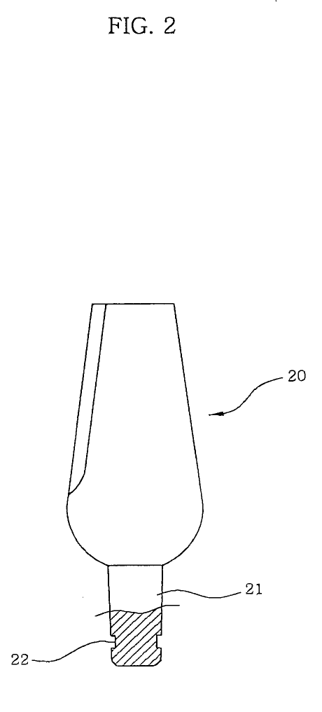

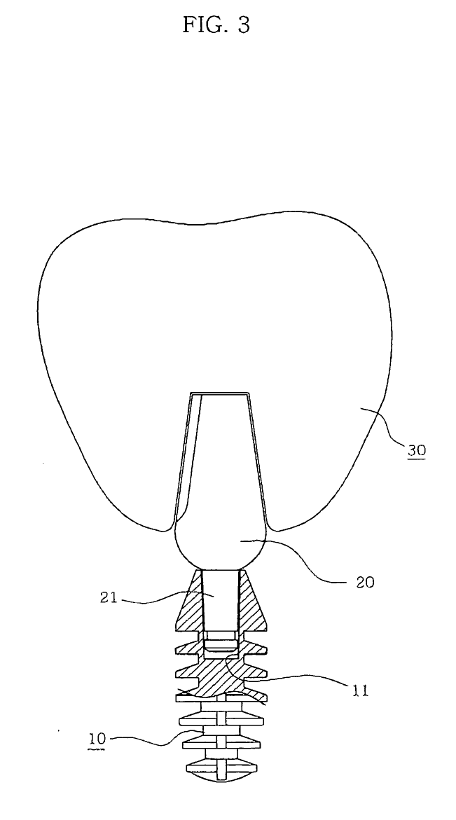

FIG. 2 is a cross sectional view illustrating an abutment according to the present invention, and FIG. 3 is a cross sectional view illustrating the entire implant system including an abutment according to the present invention.

As shown therein, the implant system includes a fixture 10 having a taper assembling hole 11 at an upper surface, an abutment 20 having a taper post part 21 inserted into the assembling hole 11 of the fixture, and a restoration 30 assembled to an upper side of the abutment.

In the present invention, at least one circular rim groove 22 is formed at the post part 21. Namely, the post part 21 is formed at the abutment 20 so that it is inserted into the assembling hole 11 of the fixture 11, and a circular rim groove 22 is formed at an outer surface of the lower side of the intermediate portion of the post part 21.

As shown in FIG. 2, when the circular rim groove 22 has a width of about 0.5 mm and a depth of about 0.2-0.3 mm when the post part 21 has an actual size of about 4 mm. The above size is not proportional to the above size or is not limited to the above size.

In addition, at least one circular rim groove 22 may be provided at the post part 21.

According to the abutment 20 according to the present invention, when the post part 11 is inserted into the assembling hole 11, almost air remaining at the portion between the bottom of the assembling hole 11 and the ends of the post part 21 is discharged to the outside, but the remaining air may remain in the space of the circular rim groove 22. Therefore, the remaining air is hardly compressed and does not act to lift up the abutment.

In the case that the outer surface of the post part 21 and the inner surface of the assembling hole 11 are not accurately contacted, the inclination is supported by the slim circular rim groove 22, so that it is possible to achieve a wider and full surface contact.

In addition, it is possible to easily hold the circular rim groove 22 using a holder or a jig when inserting and pulling out the fixture 10.

As described above, in the present invention, since the circular rim groove is formed at the post part of the abutment, a certain escape space is formed for air compressed in the assembling hole of the fixture. Therefore, in the present invention, since the air is not compressed, it is possible to prevent the abutment from being lifted up by the compressed air as compared to the conventional art.

In addition, the circular rim groove is designed to have a certain flexibility at the upper and lower sides of the post part for thereby enhancing a surface contact state between the assembling hole and the post part, so that it is possible to achieve a stable assembled state.

In the present invention, it is easy to hold the circular rim groove using a certain tool or a jig. Therefore, the operation for inserting the abutment into the fixture and pulling out the abutment from the same can be easily achieved.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In an implant system that includes a fixture having a taper assembling hole at an upper surface, an abutment having a taper post part so that it is inserted into the assembling hole of the fixture, and a restoration assembled to an upper side of the abutment, an abutment of an implant system, comprising:
at least one circular rim groove formed at an outer surface of a lower side of an intermediate portion wherein the post part is assembled into the assembling hole.
